(19) United States
(12) Patent Application Publication
(10) Pub. No.: US 2012/0104220 A1
(43) Pub. Date: May 3, 2012

(54) HOSE SUPPORT WITH RADIAL CRADLE

(76) Inventor: Albert Korson, Traverse City, MI (US)

(21) Appl. No.: 13/209,819

(22) Filed: Aug. 15, 2011

Related U.S. Application Data
(60) Provisional application No. 61/407,682, filed on Oct. 28, 2010.
(60) Provisional application No. 61/508,258, filed on Jul. 15, 2011.

(51) Int. Cl. F16L 3/16; F16L 3/18; F16L 3/205; F16L 3/12

(52) U.S. Cl. 248/577; 248/68.1

(57) ABSTRACT

A truck tractor trailer hose support for hoses and cables extending there between, including an adjustable vertical support member; a tubular hose support cradle member radially angled to approximately 90°, mounted on the vertical support member; and a mounting assembly which allows the vertical support member to returnably pivot at its base, under spring tension, to approximately 90° maximum from vertical, in any direction. The hose support cradle member is held pivotally in place on top of the vertical support member by extension springs mounted to each side of the hose support member and the corresponding sides of the vertical support member. The tubular support member and the vertical member are both returnable to their upright position by spring tension. The mounting assembly for the vertical support member is constructed of two parallel plate members with three or more compression/extension spring combinations.

### CROSS-REFERENCE TO RELATED APPLICATIONS

The present application claims the priority of U.S. Provisional Patent Application Ser. No. 61/407,682, filed Oct. 28, 2010, and U.S. Provisional Patent Application Ser. No. 61/508,258, filed Jul. 15, 2011.

### FIELD OF THE INVENTION

This invention relates to hose supports for use with hoses and cables extending between truck tractors and truck trailers.

### BACKGROUND OF THE INVENTION

Truck tractors have various hoses and electrical cables which extend from the rear of the cab to engage trailers. The purposes of these hoses includes operation of brakes, lights and other equipment installed on or in the truck trailers. Various lengths of hoses and cables are needed to connect the truck tractor with each respective truck trailer, and the required length varies depending upon the angular orientation of the tractor and the trailer during operation. As demonstrated in prior U.S. Pat. No. 5,909,861, the distance between the hose cable connecting points on a truck tractor and a truck trailer in a straight forward horizontally aligned position, with the truck trailer directly behind the truck tractor, is less than when, in a turning or maneuvering position, the truck tractor is turned at a substantial angle to the truck trailer. It is a common feature of vehicles in the trucking industry that hoses and cables are constructed of lengths which will easily accommodate the longest anticipated distance between the connection access points of each truck tractor and the corresponding truck trailer.

When hoses are of sufficient length to accommodate the longest possible distance, there is usually a significant amount of slack when the truck tractor and the truck trailer are horizontally aligned. In this particular orientation, unless sufficiently supported, these hoses are subject to damage from a variety of sources, including abrasion, kinking, as well as being susceptible to being improperly engaged with other projections or obstructions on the truck or trailer body surface while hanging loosely, and potentially severed or otherwise damaged when the alignment between the truck tractor and the truck trailer is again changed.

As reference to the prior art demonstrates, prior hose supports include those with rail connections directed to the rear side of a tractor's cab. In such applications, a spring or strap is slidably mounted on a first end to the rail. A second end of the strap or spring engages the hoses and cables near their midpoint suspending them above the truck's frame. During maneuvers tending to tension the hoses and cables, the first end of the strap or spring moves laterally along the rail allowing the hose or cables to be suspended above the frame of the truck without developing excess tension. These types of supports may communicate undesired vibrations into the cab from road-induced movement of the cables, particularly if springs are employed. Other disadvantages include the fact that the length of the hoses are cables extending beyond the support may be too long for the rail to adequately support the hoses and cables when they are uncoupled from the trailer.

Another device known to the prior art is a vertically aligned post or rod device, mounted to the tractor frame on a spring base, which engages the hoses and cables approximately mid-way between the tractor and trailer. The spring base allows the support post to be bendably resilient. Such applications, similar to the within invention, do not transmit vibrations directly into the cab. The hoses or cables cause the post to bend or pivot relative to its base with the tractor and trailer at an angle to each other and thereby prevents the development of undesirable levels of tension. When the tractor is again aligned with the trailer, the spring restores the post to an upright position. As with the rail support, when a tractor and the hoses and cables are disconnected from the trailer, they may hang lower than desired, making them vulnerable to be damage or to damage other components.

Prior art applications of spring-base mounted supports, however, have either not allowed a complete 90° pivot at the base, or have been too flexible to immediately return the vertical support member to upright status. Further, previous applications which have involved compression springs and bolts or other one-piece retaining devices have resulted in permanently bending the support bolts if the compression springs were compressed closed to the point which would have allowed the upright vertical support member to bend to 90°, from its vertical position.

The post-type, spring-based applications, to date, however, typically lack sufficient ability to both incline a sufficient distance from the vertical position, under tension, and in so doing, retain the ability to return immediately to the vertical, concurrent with the realignment of the tractor truck and truck trailer. Likewise, the mounts provided in the prior art atop such posts or pedestal-type applications may kink the hoses or cables, and do not allow or provide an optimum, radial, support for the hoses or cables, either at rest or under tension. Further, prior applications which have the hose retaining device or cradle rigidly affixed to a support member, from the standpoint of durability of the device itself, tend to break, or bend, under pressure.

The present invention is directed to the shortcomings of the prior art in providing a hose support mechanism which incorporates an adjustable height vertical member, together with a concave radial elbow support capable of pivoting independently, while the vertical member remains in an upright or inclined position.

### SUMMARY OF THE INVENTION

The present invention discloses a truck trailer hose support for hoses and cables which extend between a truck tractor and attached trailer, including an adjustable vertical support member, a tubular hose support cradle radially angled to approximately 90°, mounted atop the vertical support member and a mounting assembly which allowed the vertical support member to return pivotally to its base under spring tension to approximately 90° maximum from the vertical, in any direction.

Generally, the hose support includes a base mounting member which is comprised of a pair of parallel plates. The lower plate is affixed to the rear platform of the truck tractor. A plurality of lower compression spring members are attached, equidistant, about the perimeter of the lower plate and support the parallel upper plate. Each of the lower compression spring members, has a further corresponding upper compression spring member centered above the lower compression spring member. The compression spring members, for each spring assembly, are held in place by an extension spring initially contained within the lower compression spring, attached to the lower base plate. The upper end of each extension spring member is attached to a clevis-type bolt, extending downwardly through the corresponding upper extension spring member, with the clevis-type bolt threaded at the upper end, and a nut tightened on it to appropriate tension, to hold the upper and lower compression spring members in place.

Approximately centered upon the upper base plate is an upright support member. This support member is generally vertically inclined, and rigidly attached at its lower end to the upper base plate.

In practice, the support member is telescoping, with one tubular member slidably contained in another and held in desired place by a pin insertable through one selected set of a plurality of correspondingly aligned apertures in both telescoping members.

When angular pressure is exerted upon on the upper portion of the support member, toward a particular side of the device, the lower compression springs on one side beneath the upper base plate are compressed and the upper compression spring or springs approximately opposite and above the upper base plate are compressed by the relative downward movement on the first side, and upward movement on the second side, of the upper base plate.

Atop the vertical support member is a hose cradle. The primary feature of the hose cradle is a lower curved portion, radially bent over the top of the vertical support member in practice, to approximately 90°, with a key feature being that the radially support member has a continuous curved bottom, downwardly concave, with sides high enough to hold the supported hoses.

In the primary embodiment of the invention, the hose cradle is tubular with the supported hoses extending through the hollow interior portion thereof. In practice, as stated, so long as the lower concave portion has sides high enough to support the hoses, it is not necessary for the upper portion to be closed and, to the extent closure is desired, it may be accomplished by a hinged upper portion which may be opened to insert the hoses and closed to insure they are held in place, or other straps, or containment means removably placed over the hoses, once they are placed in position on the radial support cradle.

The radial support cradle is not rigidly attached to the vertical support member. The radial support cradle, along its bottom edge, is proximately centered on top of the vertical support member, with at least one extension spring, under tension, on each side, attached to the cradle at one end, and to the support member at the opposite end, so that the radial cradle has the ability to move for and aft, as well as sideways, under tension of the extension spring or springs on each side, which spring or springs also return it to its original position, when the force causing the movement is released.

### BRIEF DESCRIPTION OF THE DRAWINGS

Reference will now be made to the attached drawings, when read in combination with the following description, wherein like reference numbers refer to like parts throughout the several views, and in which:

FIG. 1 is a perspective view of a tractor trailer assembly, including the rearward portion of a truck tractor and the forward portion of an attached truck trailer, showing the invention, with hoses supported thereby.

FIG. 2 is a perspective side view of the invention.

FIG. 3 is an exploded view of the invention, showing all component parts in relation to each other.

FIG. 4 is perspective side view of the invention showing the radial cradle member atop the upright vertical support member and a pair of expansion springs for support.

FIG. 5 is a perspective side view of the radial cradle of the invention, a support spring, and the upper portion of the vertical upright member, with a hinged, removable top section on the radial cradle member for ease in inserting the supported hoses.

FIG. 6 is a side view of the horizontal lower and upper support plates of the invention, showing the lower and upper compression spring members, contained expansion spring member, and clevis-type bolt attachments, both on the lower base plate and above the upper base plate.

### DETAILED DESCRIPTION OF THE PREFERRED EMBODIMENT

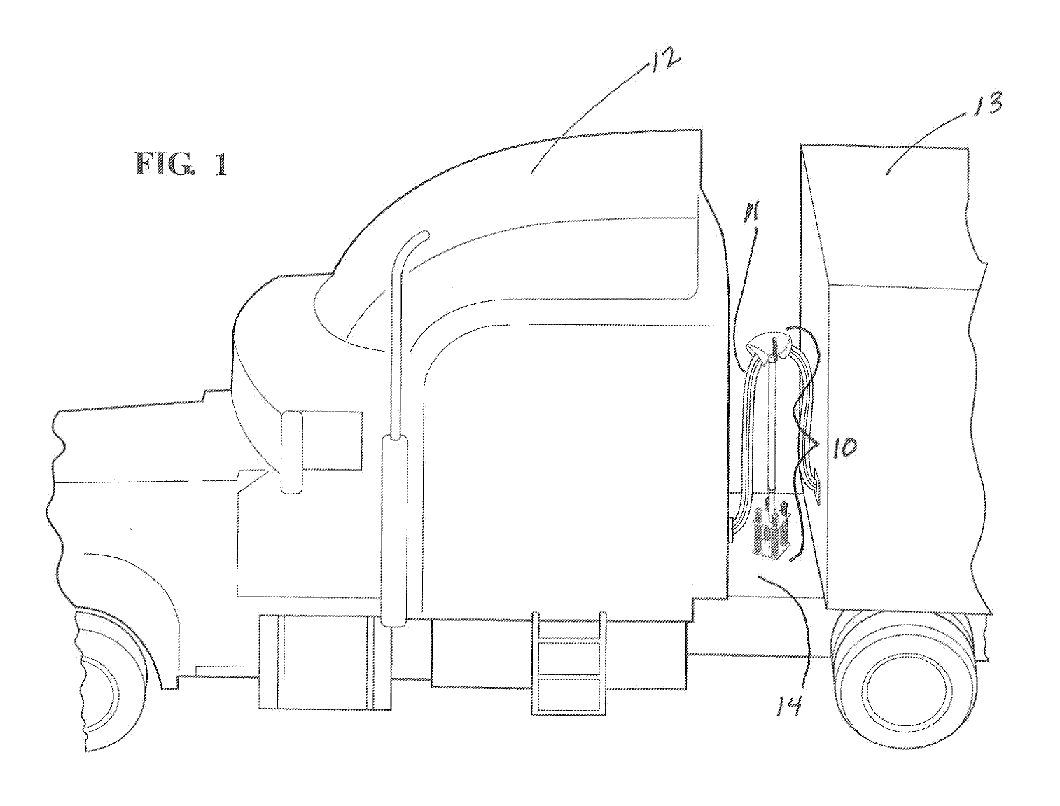

As previously described, the present invention discloses a hose support with radial cradle for support hoses extending between and used in standard operation of a truck tractor and accompanying towed truck trailer. Referring first to FIG. 1, the invention hose support device 10 is shown in general perspective with supported hoses, extending between the towing vehicle, truck tractor 12, and the towed vehicle, truck trailer 13.

The hose support device is fixably mounted on the rear platform or bed 14 of truck trailer 11, forward of trailer 13.

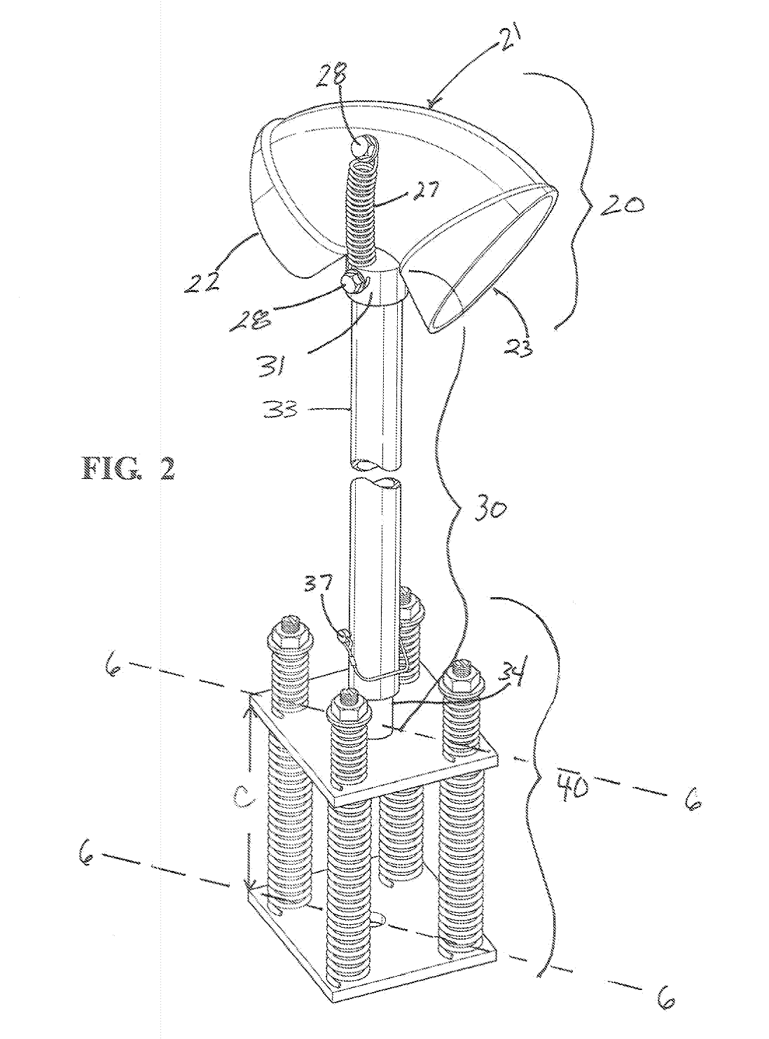

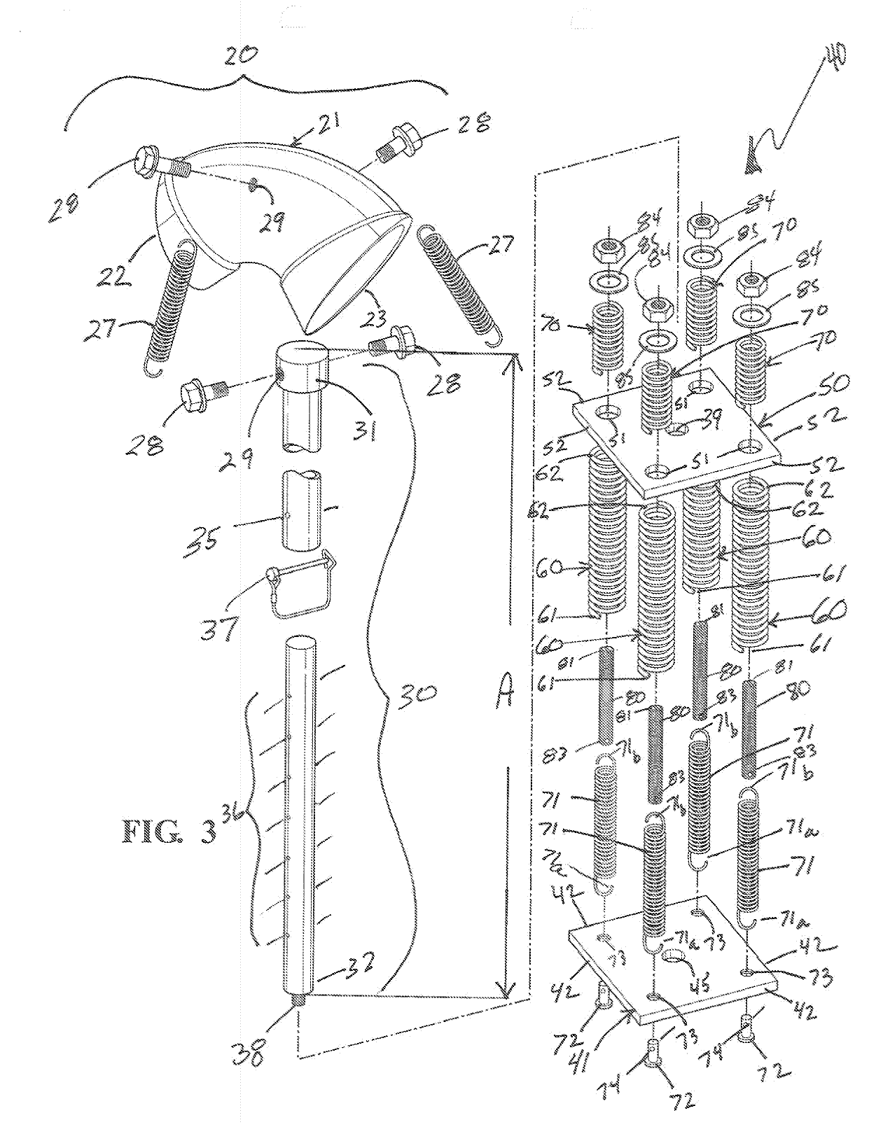

The invention 10 further comprises three basic components, a hose cradle assembly 20, a substantially upright or vertical support member or rod 30 and a base assembly 40. These components are shown in perspective in FIG. 2, and in more detail, in exploded view, in FIG. 3. Support member 30 has an upper end 31 and a lower end 32. Member 30 has a defined adjustable length A defined by the distance between lower end 32 and upper end 31. In one preferred embodiment, this adjustable feature is provided by a telescoping feature wherein the upper portion of support 30 adjacent upper end 31 is tubular and telescopingly conforming to accept the lower portion 34 of support 30, also tubular, within it in male-female relationship.

The upper portion 33 of support 30 further contains a plurality of vertically aligning holes 35 extending therethrough and the lower portion 34 of support 30 has a plurality of corresponding vertically aligned holes 36 extending therethrough.

When lower portion 34 is inserted within upper portion 33 of support 30, one extending hole 35 is aligned with one extending hole 36 and a pin 37 is inserted, as shown in FIG. 2, holding support 30 in position at defined height/length A.

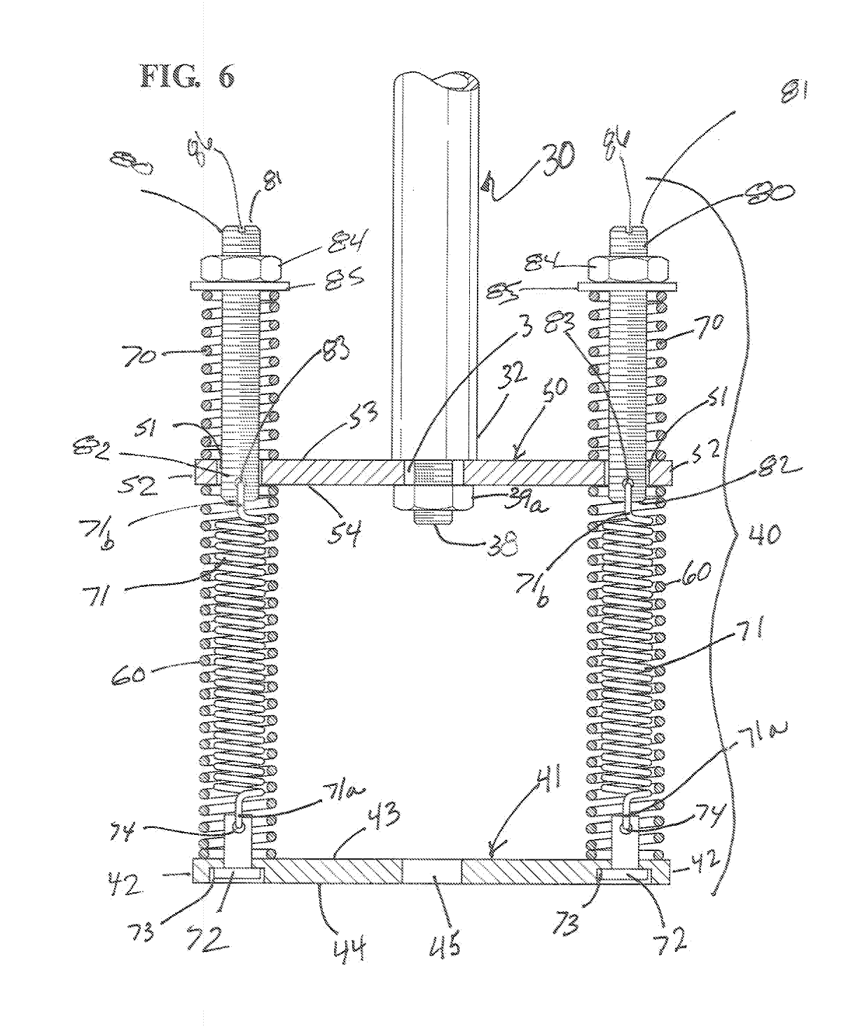

Support 30 is rigidly attached at its lower end 32 to base assembly 40. The method of such attachment is not in limitation of the invention 10 and may be a bolt 38, either conformably threaded with a conforming aperture 39 in base assembly 40, or passing through aperture 39 and held by a corresponding threaded bolt 39a as shown in FIG. 6 or by welding or other common means.

The hose support cradle assembly 20 is mounted on the upper end 31 of the support 30.

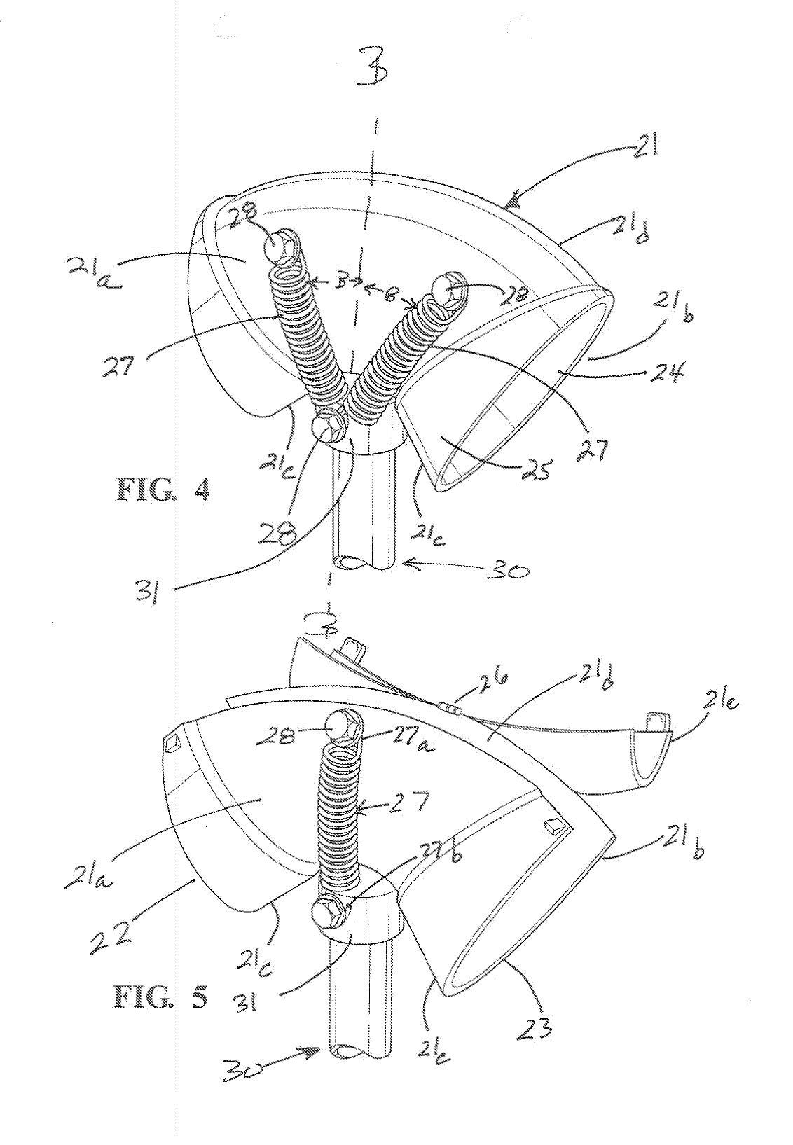

The primary cradle member 21 has a first end 22 and a second end 23 and is inwardly and downwardly concave as particularly illustrated in FIG. 5. In practice, it may be tubular with an inner surface 24 and outer surface 25, as shown in FIGS. 1, 2, 3 and 4. The primary cradle member 21a has a first side 21, a second side 21b, a bottom 21c and a top 21d. As shown in FIG. 5, top 21d may be open so that the hoses 11 may simply be placed on the cradle member 21 as opposed to being threaded therethrough. Because the inwardly concave interior surface 24 of cradle 21 with sides 21a and 21b extending outwardly and upwardly as shown in FIG. 5 provides a retention means for hoses 11, top 21d may be left open, or a hinged top 21e may be provided, moveably opened or closed by hinge 26. When closed, cradle 21 is functionally tubular as shown in FIG. 4. In practice, if having an open top 21d for insertion of hoses 11 is desirable, other means may be employed to cover top opening 21d to the extent that it is desired to prevent hoses 11 from leaving the cradle 21 during times when the unit 10 is in use, including but not limited to alternative containment means such as removable bungee cords, straps with hook and loop fastening means, or the like.

Cradle member 21 of cradle assembly 20 is radially curved from first end 22 to second end 23 within a range of 1° to 90° over and about the upper end 31 of support 30. In the embodiments shown, cradle 21 rests on upper end 31 of support 30 approximately equidistant between first end 22 and second end 23.

Cradle 21 is held moveably in place on upper end 31 of support 30 by one or more extension springs 27, with at least one extension spring 27 attached to the first side 21a of cradle 21, and at least one extension spring 27 attached to the second side 21b, of cradle 21.

When one extension spring 27 is used on each of sides 21a and 21b of cradle 21, each is attached at its first end 27a directly above support 30 and extends directly downward and is attached as its second end 27b to support 30 proximate upper end 31, as shown in FIG. 5. Threaded bolts 28 and correspondingly threaded apertures 29 are used for attaching both ends of springs 27, although the means of attachment may be rivets, hooks or other common fasteners.

In FIG. 4, an embodiment using a pair of extension springs 27 on both sides 21a and 21b of cradle 21 is shown. In such case, the first end 27a of each of the pair of springs 27 are fixed equidistant B on opposite sides of the extended axis B-B of Support 3 and second ends 27b of springs 27 are fixed substantially together on upper end 31 of Support 30.

As may be seen from the drawings, the use of extension springs 27 will allow cradle 21 to pivot on upper end 31 of Support 30, both fore and aft, and because equal extension springs 27 are placed on each of sides 21a and 21b, from side to side as well, with the cradle 21 being returnable to its original position, as shown, by contraction of extension springs 27.

Optimally, the radial curve of cradle 21 from first end 22 to second end 23 will be further limited to a range of 45° to 90° with a preferred angle of substantially 90°. The unitary radial concave surface, among other advantages, holds hoses 11 without kinking, and minimizes single point abrasion by spreading contact of the hoses 11 equally over the entire bottom inner concave surface of cradle 21 from first end 22 to second end 23.

In addition to the essentially 360° movement provided for cradle assembly 21 atop Support 30, additional flexible movement of the device is provided by base assembly 40 shown in cross-section 6-6 of FIG. 5, and as detailed in FIG. 6, as well as in perspective, in FIG. 2, and in exploded view in FIG. 3.

Base assembly 40 is comprised of two plates, positioned substantially in parallel. A lower plate member 41 with a defined perimeter edge 42, also has a top side 43 and a bottom side 44. The bottom side 44 is positioned in contact with bed 14 of truck tractor 12 when the device 10 is used in standard operation. Lower plate 41 further defines an aperture 45 through which a bolt or other fastening device may be inserted to hold the device 10 in contact with bed 14. In practice, the invention is not limited by the method of affixing lower plate 41 to bed 14, and straps or clamps or other means sufficient to maintain contact under force may be used. Positioned above lower plate 41 is upper plate 50, which, as stated, is substantially in parallel with lower plate 41. Upper plate 50 has a defined perimeter 52, substantially corresponding with the perimeter 42 of lower plate 41. Upper plate 50 has a top side 53 and a bottom side 54.

A plurality of supporting lower compression springs 60 are spaced equidistantly around the perimeter of lower plate 41, as shown in FIGS. 2 and 3. Upper plate 50 is situated above lower plate 41 with perimeter 42 corresponding to and aligned with perimeter 52. Lower compression springs 60 support upper plate 50 at a defined distance C above lower plate 41.

Upper plate 50 has a plurality of holes or apertures 51, corresponding and equal to the number of lower compression springs. Each aperture 51 is centered above a corresponding lower compression spring 60. Each lower compression spring 60 has a lower end 61 and an upper end 62 and all of the plurality of lower compression springs 60 are of equal length which, at rest, is distance B, and are placed between the bottom side 54 of upper plate 50 and the top side 43 of bottom plate 41.

A plurality of upper compression springs 70 rest upon top side 53 of upper plate 50 and correspond with the plurality of lower compression springs 60, and the plurality of apertures 51 in upper plate 50. Each upper compression spring 70 is centered on top side 53 over a corresponding aperture 51.

Moveably expandable within each lower compression spring 60 is a contained extension spring 71. Each extension spring 71 has a first end 71a attached to bottom plate 41 directly below the corresponding lower compression spring member 60 within which it is contained. The method of attachment of spring 71 to bottom plate 41 does not limit the invention, but in the embodiments shown is accomplished by a clevis-type pin member 72 extending upwardly through a corresponding aperture 73 through bottom plate 41. As used herein, “clevis-type” means an unthreaded pin with a perpendicular hole 74, through which the corresponding first end 71a and extension spring 71 may be inserted.

Each extension spring 71 further has a second end 71b.

A plurality of clevis-type bolts 80 corresponding to the plurality of upper compression springs 70 extend downward through upper compression spring 70 and into each aperture 51 in upper plate 50. Each bolt 80 has an upper end 81 and a lower end 82.

As used herein, a “clevis-type” bolt is a threaded headless bolt having a perpendicular hole or orifice 83 perpendicularly therethrough. In the embodiment shown, lower end 82 of clevis-type bolt 80 is connected to its corresponding extension spring 71, by insertion of second end 71b through orifice 83 as shown in FIG. 6. Bolt 80, at upper end 81, is adjustably held in place at desired tension by a correspondingly threaded nut 84 placed above a spring-retaining washer 85. A groove 86 is provided in upper end 82 of clevis-bolt 80 to aid in preventing rotation when nut 84 is tightened or loosened.

Thus, in operation of device 10, when pressure from the supported hoses 11 exerts directional force against cradle assembly 20 and against support 30, the upper compression springs 70 and lower compression springs 60 on opposite sides of upper plate 50 compress with the force, allowing upper plate 50 to returnably tilt in the direction in which the force is being asserted, easing pressure on support 30, and cradle assembly 20, with the contained extension springs 71 returning the upper plate 50 to substantially horizontal position, parallel to lower plate 41 after the force has subsided.

In the preferred embodiment shown in the drawings, four combination compression/extension spring assemblies, each comprised of a lower compression spring 60, an upper compression spring 70, and contained extension spring 71 are utilized, through other pluralities of such assemblies, spaced equidistant around perimeters 42 and 53 and between upper plate 50 and lower plate 41 would suffice.

Having described my invention, other and additional preferred embodiments will become apparent to those skilled in the art to which it pertains, and without deviating from the scope of the appended claims.

What is claimed is:

1. A hose support for hoses extending between a truck tractor and a truck trailer, further comprising:
a base mounting member:
a support member having an upper end and a lower end;
said lower end of the support member affixed to the base member and the support member extending upwardly therefrom;
a tubular hose cradle member having a first end and a second end and an outer surface and an inner surface, said tubular hose cradle member being radially curved from the first end to the second end at a defined angle within a range of 10° to 90°, the outer surface of said hose cradle member further having a top, a bottom, a first side and a second side;
said hose cradle member being pivotally mounted at its bottom outer surface on the upper end of the support member.

2. The invention of claim 1, wherein the means for pivotally mounting the hose cradle member at its bottom outer surface on the upper end of the support member comprises at least one extension spring member affixed to the first side of the hose cradle member and the corresponding side of the support member and at least one extension spring member affixed to the second side of the hose cradle member and the corresponding side of the support member.

3. The invention of claim 1, wherein the defined angle of the radially curved tubular hose cradle member is within a range of 45° to 90°.

4. The invention of claim 3, wherein the said defined angle is 90°.

5. The invention of claim 2, wherein two extension spring members are attached to the first side of the hose cradle member and two spring members are attached to the second side of the hose cradle member.

6. The invention of claim 5, wherein each of the two spring members affixed to the first side of the hose cradle member is affixed at the same point on their lower end to the vertical support member and one of the two spring members is affixed at its upper end at a defined distance toward the first end of the hose cradle member from the point where it pivotally contacts the vertical support member and the upper end of the other spring member is attached to the hose cradle member at a point equidistant toward the second end of the hose cradle member from said point; and the spring members attached to the second side of the hose cradle member are affixed at corresponding points on the second side of the hose support member and on the vertical support member.

7. The invention of claim 1, wherein the height of the vertical support member, defined by the distance between its upper end and lower end, is adjustable.

8. The invention of claim 7, wherein the adjustable feature of the vertical support member is a telescoping feature wherein said support member has a first tubular component and a second tubular component, wherein the second tubular component is conformed to fit slidably within the first tubular component: and a means of fixing the second tubular member at a plurality of positions within the first tubular component.

9. The invention of claim 8, wherein the meaning of fixing the second tubular member within the first tubular member further comprises a plurality of pair of vertically aligned apertures on opposing sides of the first tubular component and a corresponding plurality of pairs of vertically aligned apertures on opposing sides of the second tubular component and a pin, insertable therethrough.

10. The invention of claim 1, wherein the base mounting member further comprises:
a lower plate member and an upper plate member aligned in parallel;
said plate members having defined, corresponding perimeter edges;
a plurality of lower compression spring members of equal length supporting the upper plate member above the lower plate member;
said plurality of lower compression spring members aligned at substantiably equal intervals proximate the corresponding edges of the upper and lower plate members;
a corresponding plurality of extension spring members, each located within one of the lower compression spring members, and each having a first end attached to the lower base member, and a second end extending upwardly through the corresponding compression spring member;
said upper plate member further defining a plurality of apertures corresponding to the plurality of lower compression spring members and contained extension spring members;
a plurality of upper compression spring member corresponding to and centered above the plurality of defined apertures of the upper plate member;
each upper compression spring member containing a threaded clevis-type bolt member, extending downwardly therethrough and through the corresponding aperture;
each bolt having a lower end and an upper end;
each bolt connected at its lower end to the corresponding extension spring at its upper end; and
each threaded clevis-type bolt being held at its upper end by a conformingly threaded nut.

11. A hose support for hoses extending between a truck tractor and a truck trailer, further comprising:
a base mounting member;
a support member having an upper end and a lower end;
said lower end of the support member affixed to the base member and the support member extending upwardly therefrom;
a hose cradle member having a first end and a second end and an inwardly concave hose support surface and corresponding outer surface; said hose cradle member being radially curved from its first end to its second end at a defined angle within a range of 1° to 90°;
said hose cradle member pivotally mounted on the upper end of the support member approximately midway between the first end and second end of the cradle member with the outer surface of the cradle member proximate the support member and the concave inner surface of the cradle member being opened outwardly above the support member;
the cradle member having a bottom, a first side, a second side and an open upper side, said bottom, first side and second side being unitary; and
the means for pivotally mounting the hose cradle member on the support member being at least one extension spring each having a first end affixed to the first side of the cradle member and a second end affixed to the support member, and at least one extension spring having a first end attached to the second side of the cradle member and a second end attached to the support member.

12. The invention of claim 11, wherein the base mounting member further comprises:
a lower plate member and an upper plate member substantially aligned in parallel, said plate members having defined correspondingly perimeter edges
the lower plate member having a top side and a bottom side;
the upper plate member having a top side and a bottom side;
the support member attached at its lower end to the top side of the upper plate member;
the bottom side of the upper plate member facing the upper side of the lower plate member;
the upper plate member moveably maintained in returnable parallel relation with the lower plate member by a plurality of lower compression springs placed equidistant around the perimeter edges between the bottom side of the upper plate member and the upper side of the lower plate member, and a corresponding plurality of upper compression spring members mounted on the upper surface of the upper plate member, each upper compression spring member mounted directly above a corresponding lower compression spring member; and
a means for maintaining each upper compression spring member above each corresponding lower compression spring member.

13. The invention of claim 11, wherein the defined angle of the radially hose cradle member is within a range of 45° to 90°.

14. The invention of claim 11, wherein two extension spring members are attached to the first side of the hose cradle member, and two extension spring members are attached to the second side of the hose cradle member.

15. The invention of claim 14, wherein each of the two spring members affixed to the first side of the hose cradle member is affixed at the same point on their lower end to the vertical support member and one of the two spring members is affixed at its upper end at a defined distance toward the first end of the hose cradle member from the point where it pivotally contacts the vertical support member and the upper end of the other spring member is attached to the hose cradle member at a point equidistant toward the second end of the hose cradle member from said point; and the spring members attached to the second side of the hose cradle member are affixed at corresponding points on the second side of the hose cradle member and on the vertical support member.

16. The invention of claim 11, wherein the height of the support member, defined by the distance between its first end and second end, is adjustable.

17. The invention of claim 16, wherein the adjustable feature of the vertical support member is a telescoping feature wherein said support member has a first tubular component and a second tubular component, wherein the second tubular component is conformed to fit slidably within the first tubular component: and a means of fixing the second tubular member at a plurality of positions within the first tubular component.

18. The invention of claim 17, wherein the means of fixing the second tubular member within the first tubular member further comprises a plurality of pair of vertically aligned apertures on opposing sides of the first tubular component and a corresponding plurality of pairs of vertically aligned apertures on opposing sides of the second tubular component and a pin, insertable therethrough.

19. The invention of claim 12, wherein the means of keeping each upper compression spring member in corresponding relationship to each lower compression spring member comprises:
each upper plate member defining a plurality of apertures, one aperture corresponding to each upper and lower compression spring, with the lower compression spring centered below said aperture and the corresponding upper compression spring centered above said aperture;
a plurality of extension spring members corresponding to and contained within each lower compression spring member, each extension spring member having a lower end and an upper end, with the lower attached to the lower base member;
a plurality of threaded clevis-type bolt members, corresponding plurality of upper compression spring members, each extending downwardly therethrough and through the corresponding aperture;
each bolt having a lower end and an upper end;
each bolt connected at its lower end to the upper end of the extension spring member extending upwardly through the corresponding lower compression spring member; and
each threaded clevis-type bolt being held at its upper end by a conformingly threaded nut.

20. The invention of claim 19, wherein the corresponding pluralities of upper extension springs, lower compression springs, extension springs, apertures, clevis-type bolts, and nuts, is at least four.

21. The invention of claim 19, wherein each extension spring is affixed at its first end to the lower plate member by a clevis-type pin affixed to the lower plate member.
